(19) United States
(12) Patent Application Publication
(10) Pub. No.: US 2013/0067663 A1
(43) Pub. Date: Mar. 21, 2013

(54) BLEACHING OF FOOD STAINS

(71) Applicant: The Procter & Gamble Company, Cincinnati, OH (US)

(72) Inventors: Hansjoerg Hufnagel, Schwalbach am Taunus (DE); Stefano Scialla, S. Polomba (IT); Luca Sarcinelli, S. Polomba (IT)

(73) Assignee: The Procter & Gamble Company, Cincinnati, OH (US)

(21) Appl. No.: 13/621,892

(22) Filed: Sep. 18, 2012

(30) Foreign Application Priority Data
Sep. 20, 2011 (EP) 11181916.5

(51) Int. Cl. C11D 3/60; D06L 1/16

(52) U.S. Cl. 8/137; 510/309; 510/310

(57) ABSTRACT

The need for a bleaching composition providing improved removal of fatty stains and red food stains, particularly during low temperature washing, can be met by incorporating an aryliminium organic bleach catalyst, an oxygen-based bleach source, and decanoyloxybenzoic acid.

### FIELD OF THE INVENTION

The present invention relates to the improved removal of stains, particularly fatty stains and red food stains, through the use of bleaching compositions that comprise an aryliminium organic bleach catalyst, a peroxygen source, and a decanoyloxybenzoic acid.

### BACKGROUND OF THE INVENTION

Consumers desire bleaching compositions for addition during a laundry cycle that remove a broad array of stains, preferably without requiring a pretreatment step.

The use of oxygen-based bleach sources, including peracids and their salts, in conjunction with bleach activators, such as diacyl peroxides to effectively remove stains is known.

However, certain stains are more difficult to remove than others, particularly at low wash temperatures. Such stains include those derived from animal and vegetable fats, as well as red food stains such as those derived from tomato sauce, carrot, and the like. Stain removal can be improved by washing and bleaching at high temperatures. However, washing at high temperature damages delicate fabrics, and leads to accelerated colour fading. Even with a combination of a peroxygen source and bleach activator, removal of fatty stains and red food stains has remained unsatisfactory, particularly during low temperature bleaching.

Accordingly, there remains a need for a bleaching composition that delivers improved bleaching of fatty stains and red food stains. There is also a need for a bleaching composition that delivers improved bleaching of fatty stains and red food stains even during low temperature laundry.

It was surprisingly found that fabric cleaning composition comprising an oxygen-based bleaching source and at least a first bleach activator and a second bleach activator, wherein, the first bleach activator when in an aqueous environment produces a first diacyl peroxide, and the second bleach activator when in an aqueous environment produces a second diacyl peroxide; and, wherein, the first diacyl peroxide and the second diacyl peroxide are different, solved this problem.

### SUMMARY OF THE INVENTION

In a first aspect, the present invention is to a fabric cleaning composition comprising an oxygen-based bleaching source and at least a first bleach activator and a second bleach activator; wherein, the first bleach activator when in an aqueous environment produces a first symmetric diacyl peroxide, and the second bleach activator when in an aqueous environment produces a second symmetric diacyl peroxide; and wherein, the first symmetric diacyl peroxide and the second symmetric diacyl peroxide are different.

In a second aspect, the present invention provides a method for removing fabric stains, particularly removing fatty stains, red food stains, or combinations thereof, comprising the steps of:
(a) forming an aqueous bleach-containing wash solution comprising the fabric cleaning composition described in the first aspect of the present invention, a laundry detergent composition, and water;
(b) contacting the fabric with said bleach-containing wash solution; and
(c) subjecting said fabrics contacted with said bleach containing wash solution to a laundry wash cycle.

### DETAILED DESCRIPTION OF THE INVENTION

### The Bleaching Composition

The fabric cleaning compositions of the present invention comprise an oxygen-based bleaching source and at least a first bleach activator and a second bleach activator, wherein, the first bleach activator when in an aqueous environment produces a first diacyl peroxide, and the second bleach activator when in an aqueous environment produces a second diacyl peroxide; and, wherein, the first diacyl peroxide and the second diacyl peroxide are different.

Suitable forms include particulate compositions, and liquid compositions, though particulate compositions are preferred. Particulate compositions are preferred as they remain more stable over time. This is due to the limited mobility between components of the compositions, thus they have less opportunity to interact/react when in storage. By “particulate” it is meant herein powders, pearls, granules, tablets and the like. Particulate compositions are preferably dissolved in an appropriate solvent, typically water, before being applied onto the fabrics to be treated.

The fabric cleaning compositions of the present invention are preferably granular particulate compositions. These compositions can be made by a variety of methods well known in the art, including dry-mixing, spray drying, agglomeration and granulation and combinations thereof. The compositions herein can be prepared with different bulk densities, including for conventional granular products having a bulk density of from 500 g/l, to 700 g/l. However, “concentrated” particulate bleaching compositions are preferred, having a bulk density preferably greater than 600 g/l, more preferably from 600 g/l, to 1200 g/l, most preferably 800 g/l to 1100 g/l.

Preferably, the fabric cleaning compositions of the present invention are bleaching additive compositions. Additive compositions are generally added together with a laundry detergent composition into a washing machine, to improve fabric whitening and stain removal, and are active in the same wash-cycle. By contrast, so-called ‘spotter’ or ‘pretreater’ compositions are generally applied undiluted onto fabrics, prior to washing or rinsing the fabrics and are left to act thereon for an effective amount of time. ‘Soakers’ are contacted, mostly in diluted form, with fabrics prior to washing or rinsing of the fabrics with water. ‘Rinse-added’ compositions are contacted, mostly in diluted form, with fabrics during rinsing of the fabrics with water.

The fabric cleaning compositions herein preferably have a pH, when diluted into 500 times its weight of water, and measured at 25° C., of from 7 to less than 12, more preferably from 7.5 to less than 11, most preferably from 8 to less than 11.

### Oxygen-Based Bleach Source

The oxygen-based bleach source supplies the oxygen atoms that are transferred to the oxidizeable substrate and as such, are an essential feature of the bleaching system. The fabric cleaning composition of the present invention preferably comprises from 15% to 50%, preferably from 20% to 45%, more preferably from 25% to 40%, most preferably from 25% to 35%, by weight of an oxygen-based bleach source.

The oxygen-based bleach source is preferably selected from the group comprising phthalimido peroxycaproic acid (PAP), perborate salts, percarboxylic acids and salts, percarbonic acids, percarbonates, perimidic acids and salts, peroxymonosulphuric acids and salts, urea peroxide, and mixtures thereof. Percarbonates are particularly preferred for their greater rate of dissolution, a more environmentally friendly profile and the advantage of concurrently generating hydrogen peroxide, while also liberating carbonate. Thus, they give a higher pH than perborates and favour perhydrolysis. Sodium percarbonate is a suitable percarbonate. Perborate sources, such as sodium perborate, have good stability and selectivity. Other preferred perborate sources include the tetrahydrate and/or the monohydrate forms. Another preferred peroxygen source is phthalimido peroxycaproic acid (PAP). A suitable salt of a peroxymonosulphuric acid is potassium peroxymonosulphate (potassium monopersulphate), or its triple salt: 2KHSO₅.KHSO₄.K₂SO₄. Other suitable persalts include: persulphates, perphosphates, persilicates, and mixtures thereof. Peroxides are also suitable peroxygen sources. Typical peroxides include organic peroxides, such as diacyl peroxides (DAP), which improve bleaching of specific stains such as stains caused by spaghetti sauce or barbecue sauce. One suitable example is dibenzoyl peroxide. Other suitable hydrogen peroxide sources are described in detail in Kirk Othmer's Encyclopaedia of Chemical Technology, 4th Ed (1992, John Wiley & Sons), Vol. 4, pp. 271-300 “Bleaching Agents (Survey)”. Since peroxyacid acids are particularly useful for removing dingy soils from textiles, the bleaching composition preferably comprises peroxyacid in combination with DAP, to bleach both dingy soil stains as well as stains resulting from spaghetti and the like. As used herein, “dingy soils” are those which build up on textiles after numerous cycles of usage and washing and thus, cause the white textile to have a gray or yellow tint.

### Bleach Activators

The fabric cleaning composition of the present invention comprises at least a first bleach activator and a second bleach activator. The first bleach activator and the second bleach activator are different. The first bleach activator when in an aqueous environment produces a first symmetric diacyl peroxide, and the second bleach activator when in an aqueous environment produces a second symmetric diacyl peroxide. Also, the first symmetric diacyl peroxide and the second symmetric diacyl peroxide are different. By symmetric diacyl peroxide we mean a diacyl peroxide molecule wherein the two acyl moieties R—CO and R′—CO are attached to the peroxide backbone as shown in the following structure;

R—CO—O—O—OC—R′

are the same, i.e. R is the same as R′. On the other hand, an asymmetric diacyl peroxide is one where, in the above chemical structure, R is different from R′. Without wishing to be bound by theory, it is believed that the two different symmetric diacyl peroxides provide a synergistic stain removal activity. Indeed, the presence of the two symmetric diacyl peroxides at a particular concentration showed improved stain removal than the presence of an equimolar concentration of just one of the symmetric diacyl peroxides. Without wishing to be bound by theory, it is believed that the simultaneous presence of a first and a second bleach activator in the wash solution also leads to the formation of a third, asymmetric diacyl peroxide, which further contributes to enhance bleaching performance.

In a preferred embodiment, the first and second diacyl symmetric peroxides are each separately selected from the group comprising C9 diacyl peroxide, C10 diacyl peroxide, and C12 diacyl peroxide.

In a preferred embodiment, the first symmetric diacyl peroxide is a C9 diacyl peroxide, and the second symmetric diacyl peroxide is a C10 diacyl peroxide. It was surprisingly found that this particular combination of diacyl peroxides gave the best stain removal performance.

In a preferred embodiment, at least one of the bleach activators used has the general formula:

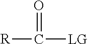

wherein R is an alkyl group, linear or branched, containing from about 1 to 11 carbon atoms and LG is a suitable leaving group. As used herein, a “leaving group” is any group that is displaced from the bleach activator as consequence of nucleophilic attack on the bleach activator by the perhydroxide anion, i.e. perhydrolysis reaction.

Generally, a suitable leaving group is electrophilic and is stable such that the rate of the reverse reaction is negligible. This facilitates the nucleophilic attack by the perhydroxide anion. The leaving group must also be sufficiently reactive for the reaction to occur within the optimum time frame, for example during the wash cycle. However, if the leaving group is too reactive, the bleach activator will be difficult to stabilize. These characteristics are generally paralleled by the pKa of the conjugate acid of the leaving group, although exceptions to this convention are known. The conjugate acid of the leaving group in accordance with the present invention preferably has a pKa in a range from about 4 to about 13, more preferably from about 6 to about 11, and most preferably from about 8 to about 11.

Preferably, the leaving group has the formula:

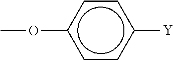

wherein Y is selected from the group consisting of SO₃⁻M⁺, COO⁻M⁺, SO₄M⁺, PO₄⁻M⁺, PO₃⁻M⁺. (N⁺R²₃)X⁻ and O←N(R²₂), M is a cation and X is an anion, both of which provide solubility to the bleach activator, and R² is an alkyl chain containing from about 1 to about 4 carbon atoms or H. In accordance with the present invention, M is preferably an alkali metal, with sodium being most preferred. Preferably, X is a hydroxide, methylsulfate or acetate anion.

Other suitable leaving groups have the following formulas

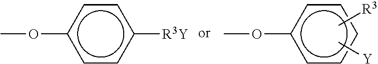

wherein Y is the same as described above and R³ is an alkyl chain containing from about 1 to about 8 carbon atoms, H or R².

While numerous bleach activators as described above are suitable for use in the present bleach composition, a preferred bleach activator has the formula:

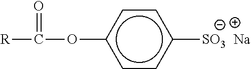

wherein R is an alkyl chain, linear or branched, containing from 1 to 15 carbon atoms. More preferably, R is an alkyl chain, linear or branched, containing from 3 to 13, even more preferably from 8 to 11.

Most preferably, according to the present invention, at least one of the bleach activators has the formula:

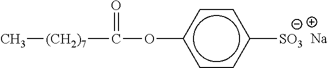

which is also referred to as sodium n-nonyloxybenzene sulfonate (hereinafter referred to as “NOBS”).

In one embodiment, the first bleach activator and the second bleach activator are independently selected from the group comprising nonanoyloxybenzene sulphonate (NOBS), sodium 4-(isononanoyloxy)benzenesulphonate (iso-NOBS), decanoyloxybenzene sulphonate (DOBS), dodecanoyloxybenzene sulphonate (LOBS), decanoyloxybenzoic acid (DOBA).

In a preferred embodiment the first bleach activator is nonanoyloxybenzene sulphonate (NOBS) and the second bleach activator is decanoyloxybenzoic acid (DOBA). In another embodiment, the first bleach activator is nonanoyloxybenzene sulphonate (NOBS) and the second bleach activator is decanoyloxybenzene sulphonate (DOBS). In yet another embodiment, the first bleach activator is nonanoyloxybenzene sulphonate (NOBS) and the second bleach activator is dodecanoyloxybenzene sulphonate (LOBS).

Preferably the molar ratio of first bleach activator to second bleach activator is from 1:10 to 10:1, in particular from 1:5 to 5:1 or from 1:3 to 3:1. Preferably the molar ratio of nonanoyloxybenzene sulphonate (NOBS) to decanoyloxybenzoic acid (DOBA) (or LOBS or DOBS) is from 1:10 to 10:1, in particular from 1:5 to 5:1 or from 1:3 to 3:1. It was surprisingly found that at these concentrations and this ratio, the bleach activators showed the best stain removal performance.

These bleach activators may be readily synthesized by well known reaction schemes or purchased commercially, neither of which is more preferred.

The bleaching composition may comprise from 0.5% to 30% in particular from 1 to 15% or from 2 to 10% of the first bleach activator. The bleaching composition may comprise from 0.5% to 30% in particular from 1 to 15% or from 2 to 10% of the second bleach activator. The bleaching composition may comprise from 1% to 50% in particular from 2 to 30% or from 5 to 20% of bleach activators.

### Optional Ingredients

The bleaching compositions herein may further comprise other optional ingredients such as those selected from the group comprising surfactants, enzymes, fillers, chelating agents, radical scavengers, antioxidants, stabilizers, builders, soil suspending polymer, polymeric soil release agents, dye transfer inhibitor, solvents, suds controlling agents, suds booster, brighteners, perfumes, pigments, dyes, metal-containing bleach catalysts, transition metal complexes and the like.

In one embodiment, the fabric cleaning composition of the present invention comprises an aryliminium organic bleach catalysts. Aryliminium organic bleach catalysts improve the bleaching performance, particularly at low temperatures. They are capable of accepting an oxygen atom from an oxygen-based bleach source and transferring the oxygen atom to an oxidizable substrate. The bleaching system for use in the present invention may also include other bleaching agents such as those selected from the group comprising additional bleach activators, metal-containing bleach catalysts, transition metal complexes of macropolycyclic rigid ligands, and mixtures thereof.

The fabric cleaning composition of the present invention preferably comprises from 0.02% to 0.20%, preferably from 0.05% to 0.15%, more preferably from 0.08% to 0.15% by weight of the fabric cleaning composition of an aryliminium organic bleach catalyst selected from the group comprising aryliminium cations, aryliminium zwitterions, and mixtures thereof.

Suitable aryliminium zwitterions may be selected from the group comprising:

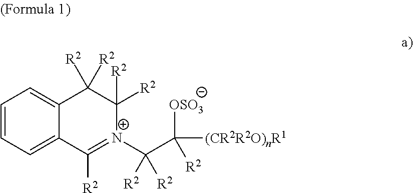

wherein: in Formula 1, R¹ is selected from the group consisting of: H, a branched alkyl group containing from 3 to 24 carbons, and a linear alkyl group containing from 1 to 24 carbons. Preferably, R¹ is a branched alkyl group comprising from 6 to 18 carbons, or a linear alkyl group comprising from 5 to 18 carbons, more preferably each R¹ is selected from the group consisting of: 2-propylheptyl, 2-butyloctyl, 2-pentylnonyl, 2-hexyldecyl, n-hexyl, n-octyl, n-decyl, n-dodecyl, n-tetradecyl, n-hexadecyl, n-octadecyl, iso-nonyl, iso-decyl, iso-tridecyl and iso-pentadecyl; R² is independently selected from the group consisting of: H, a branched alkyl group comprising from 3 to 12 carbons, and a linear alkyl group comprising from 1 to 12 carbons. Preferably R² is independently selected from H and methyl groups; n is an integer from 0 to 1;

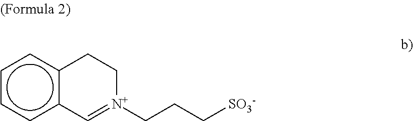

3-(3,4-dihydroisoquinolinium)propane sulphonate;
   and mixtures thereof.

More preferably, the aryliminium zwitterions have the structure:

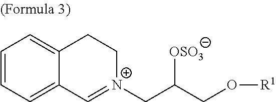

wherein: in Formula 3, R¹ is a branched alkyl group containing from 9 to 24 carbons or linear alkyl group containing from 11 to 24 carbons, preferably, each R¹ is a branched alkyl group containing from 9 to 18 carbons or linear alkyl group containing from 11 to 18 carbons, more preferably each R¹ is selected from the group consisting of 2-propylheptyl, 2-butyloctyl, 2-pentylnonyl, 2-hexyldecyl, n-dodecyl, n-tetradecyl, n-hexadecyl, n-octadecyl, iso-nonyl, iso-decyl, iso-tridecyl and iso-pentadecyl. Most preferred, are the inner salts of 3-(3,4-dihydroisoquinolinium)propane sulphonate, sulphuric acid mono-[2-(3,4-dihydro-isoquinolin-2-yl)-1-(2-butyl-octyloxymethyl)-ethyl]ester, and mixtures thereof.

Suitable aryliminium cations and polycations include ions having the structure:

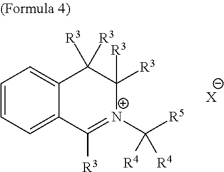

wherein: in Formula 4, R³ is independently selected from the group consisting of: H and methyl groups. Preferably, R³ is H. R⁴ and R⁵ are independently selected from the group consisting of: H, a branched alkyl group containing from 3 to 12 carbons, and a linear alkyl group containing from 1 to 12 carbons. Preferably, R⁴ and R⁵ are H or methyl, more preferably, R⁴ and R⁵ are H. X⁻ is a charge-balancing counter-ion; preferably a bleach-compatible counter-ion. Most preferred, are N-methyl-3,4-dihydroisoquinolinium tetrafluoroborate, N-methyl-3,4-dihydroisoquinolinium p-toluene sulphonate, and mixtures thereof.

In a most preferred embodiment, the aryliminium organic bleach catalyst is 2-[3-[(2-butyloctyl)oxy]-2-(sulfooxy)propyl]-3,4-dihydroisoquinolinium, inner salt.

### Method of Treating Fabrics

The present invention encompasses a method of removing fabric stains, particularly removing fatty stains, red food stains, or combinations thereof, comprising the steps of:
a) forming an aqueous bleach-containing wash solution comprising the fabric cleaning composition of any preceeding claim, a laundry detergent composition, and water;
b) contacting the fabric with said bleach-containing wash solution; and
c) subjecting said fabrics contacted with said bleach containing wash solution to a laundry wash cycle.

Such a method typically includes the steps of forming an aqueous bath comprising water, a laundry detergent composition, preferably a granular laundry detergent, and a fabric cleaning composition according to the present invention, and subsequently contacting said fabrics with said aqueous bath. Said bleaching compositions are typically dissolved in up to 500 times its own weight, preferably from 5 to 350 times and more preferably from 10 to 200 times.

Preferably, the aqueous bath comprises from 100 to 5000 ppm, more preferably from 200 to 4000 ppm, most preferably from 300 to 3000 ppm of the fabric cleaning composition of the present invention. Preferably, the aqueous bath comprises from 200 to 25000 ppm, more preferably from 300 to 15000 ppm, most preferably from 400 to 10000 ppm of the fabric cleaning composition of the present invention.

The method of removing fabric stains according to the present invention delivers effective stain removal and stain release performance, particularly of fatty stains and red food stains. Fatty stains comprise chicken fat, beef fat, pork fat, and mixtures thereof. Red food stains comprise tomato juice, carrot juice and mixture thereof.

By “laundry detergent composition” it is meant herein, laundry detergent compositions typically available on the market. Said laundry detergent composition comprises at least one surfactant. Said laundry detergent compositions may be formulated as particulates (including powders, pearls, granules, tablets and the like), liquids (liquids, gels, and the like) as well as detergent forms based on water-soluble or water-permeable pouches comprising liquids and/or particulates (such as liquid-tabs). Suitable particulate laundry detergent compositions are for example DASH Powder®, ARIEL Tablets®, ARIEL Powder® and other products sold under the trade names ARIEL® or TIDE®. In a preferred embodiment herein, the laundry detergent composition is a particulate laundry detergent composition, more preferably in the form of a powder, pearl, granule or tablet.

In a preferred embodiment according to the present invention, the laundry detergent composition as described herein and, the fabric cleaning composition herein are dissolved or dispersed, preferably substantially dissolved or dispersed, in the aqueous bath formed in the method according to the present invention. By “substantially dissolved or dispersed” it is meant herein, that at least 50%, preferably at least 80%, more preferably at least 90%, even more preferably at least 95%, still more preferably at least 98%, and most preferably at least 99%, of said laundry detergent composition and/or said fabric cleaning composition are dissolved or dispersed in the aqueous bath formed in the method according to the present invention.

The fabric cleaning composition and the conventional detergent composition may be delivered into the washing machine either by charging the dispenser drawer of the washing machine with one or both of the compositions or by directly charging the drum of the washing machine with one or both of the detergents. More preferably the fabric cleaning composition is directly placed into the drum of the washing machine, preferably using a dosing device, such as a dosing ball (such as the Vizirette®). Even more preferably the fabric cleaning composition and the conventional detergent composition are both placed into the drum of the washing machine, preferably using suitable dosing devices such as dosing balls, dosing nets etc. The fabric cleaning composition is preferably delivered to the main wash cycle of the washing machine before, but more preferably at the same time as the conventional detergent composition.

The present invention also incorporates the use of any of the fabric cleaning composition of the present invention, for removing fatty stains, red food stains, and mixtures thereof, from fabrics.

### Example 1

Bleaching compositions, comprising the following levels of peroxygen source (sodium percarbonate), of first bleach activator (NOBS) and second bleach activators (DOBA) were prepared:

| | Wt % | | |
|---|---|---|---|
| Bleaching | Sodium | Wt % | Wt % |
| composition | percarbonate | NOBS | DOBA |
| Composition A | 30% | 9.12* | — |
| (Comparative) | | | |
| Composition 1 | 30% | 5.32* | 3.16* |

(*9.12% of NOBS are equimolar to a combination of 5.32% of NOBS and 3.16% of DOBA)

Compositions A and 1 comprised the same amount of TAED, enzymes, aesthetics (perfume and colored speckles), chelants, surfactants, polymers, optical brightener, and filler.

Technical stain swatches were purchased from Warwick Equest Ltd (Consett, County Durham, UK) and washed in conventional western European washing machines, selecting the cotton cycle at 40° C., using 30 g of the respective treatment composition (either A or 1) and 80 g of granular detergent (Ariel Regular Powder detergent commercially available from the Italian market). Image analysis was used to compare each stain to an unstained fabric control. Software converted images taken into standard colorimetric values and compared these to standards based on the commonly used Macbeth Colour Rendition Chart, assigning each stain a colorimetric value (Stain Level). Eight replicates of each were prepared.

The stain removal index was then calculated according to the following formula:

| | SRI | SRI |
|---|---|---|
| Stain | Comp. A | Comp. 1 |
| Bertoli Olive Oil | 74.2 | 76.6 |
| Home Pride BBQ | 71.5 | 74.7 |
| Sauce | | |
| Libby's Tomato | 88.1 | 90.4 |
| Juice | | |
| Tender Chicken | 68.3 | 72.4 |
| Tomato Juice | 88.1 | 91.2 |

$Stain Removal Index ( SRI ) = \frac{Δ {E}_{initial} - Δ {E}_{washed}}{Δ {E}_{initial}} \times 100$ ΔEᵢₙᵢₜᵢₐₗ = Stain level before washing
ΔE_{washed} = Stain level after washing

All of the above numerical differences between the stain removal index of composition A vs. composition 1 were confirmed to be statistically significant at 90% confidence level (Student's t-test). The test demonstrates that composition 1, which combines NOBS and DOBA as bleach activators according to the present invention, is significantly better than composition A, which contains only NOBS at an equimolar concentration vs. the NOBS+DOBA combination in composition 1. Therefore the improvement delivered by composition 1 is significantly higher than would be expected from a simple additive effect and confirms a positive synergistic benefit from the combination of two activators (NOBS and DOBA) according to the present invention.

### Example 2

Compositions B to E are compositions according to the present invention:

| Ingredients | B | C | D | E |
|---|---|---|---|---|
| Sodium percarbonate | 33.0 | 40.0 | 25.0 | 30.0 |
| Tetraacetyl ethylene diamine | — | 9.0 | 4.4 | 4.0 |
| Nonanoyloxybenzene sulphonate | 10.0 | 3.7 | 4.0 | 2.0 |
| (NOBS) | | | | |
| Decanoyloxybenzoic Acid | 5.0 | 3.0 | 2.6 | 4.7 |
| (DOBA) | | | | |
| Polyamine polymer | 6.0 | — | — | 6.0 |
| Acrylic Acid/Maleic Acid | 2.0 | — | — | — |
| Copolymer | | | | |
| (1-hydroxy-1-phosphono- | 1.3 | — | 1.2 | — |
| ethyl)phosphonic acid (HEDP) | | | | |
| Carboxymethyl cellulose | — | 0.1 | 0.5 | — |
| Polyvinylpyrrolidone (PVP) | — | 0.2 | 0.1 | — |
| C12-C16 Alkylbenzene | 1.2 | 4.5 | 3.7 | — |
| sulphonic acid | | | | |
| C12-C16 alkyl 7-ethoxylate | 0.5 | 1.0 | 0.4 | 0.1 |
| Sodium lauroyl sarcosinate | — | 1.0 | — | — |
| Sodium xylene sulphonate | — | 1.1 | — | — |
| Mannanase (1) | 0.2 | — | 0.1 | — |
| Protease (2) | — | 0.5 | 0.1 | — |
| Cellulase (3) | 0.2 | 0.2 | 0.1 | 0.1 |
| Lipase granulate (4) | 0.1 | 0.2 | 0.05 | 0.3 |
| Brightener | 0.1 | — | 0.07 | — |
| Sodium sulphate | Balance | Balance | Balance | Balance |

(1) Mannaway, from Novozymes (Denmark), 4 mg active enzyme per gram.
(2) Savinase, from Novozymes (Denmark), 15.8 mg active enzyme per gram.
(3) Celluclean, from Novozymes (Denmark), 15.6 mg active enzyme per gram.
(4) Lipex, from Novozymes (Denmark), 1.88 mg active enzyme per gram.

All percentages, ratios and proportions used herein are by weight percent of the composition, unless otherwise specified. All average values are calculated “by weight” of the composition or components thereof, unless otherwise expressly indicated.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A fabric cleaning composition comprising an oxygen-based bleaching source and at least a first bleach activator and a second bleach activator;
wherein, the first bleach activator when in an aqueous environment produces a first symmetric diacyl peroxide, and the second bleach activator when in an aqueous environment produces a second symmetric diacyl peroxide; and,
wherein, the first symmetric diacyl peroxide and the second symmetric diacyl peroxide are different.

2. The fabric cleaning composition of claim 1, wherein the first and second symmetric diacyl peroxides are each separately selected from the group comprising C9 diacyl peroxide, C10 diacyl peroxide, and C12 diacyl peroxide.

3. The fabric cleaning composition of claim 2, wherein the first bleach activator and the second bleach activator are independently selected from the group comprising nonanoyloxybenzene sulphonate, sodium 4-(isononanoyloxy)benzenesulphonate, decanoyloxybenzene sulphonate, dodecanoyloxybenzene sulphonate, decanoyloxybenzoic acid.

4. The fabric cleaning composition of claim 3, wherein the first bleach activator is nonanoyloxybenzene sulphonate and the second bleach activator is decanoyloxybenzoic acid.

5. The fabric cleaning composition of claim 3, wherein the ratio of nonanoyloxybenzene sulphonate to decanoyloxybenzoic acid is from 1:3 to 3:1.

6. The fabric cleaning composition of claim 1, wherein the cleaning composition comprises from 15% to 50%, by weight of the fabric cleaning composition of an oxygen-based bleach source.

7. The fabric cleaning composition of claim 1, wherein the oxygen-based bleaching source is selected from the group comprising phthalimido peroxycaproic acid, perborate salts, percarboxylic acids and salts, percarbonic acids, percarbonates, perimidic acids and salts, peroxymonosulphuric acids and salts, urea peroxide, and mixtures thereof.

8. The fabric cleaning composition of claim 7, wherein the oxygen-based bleaching source is percarbonate.

9. The fabric cleaning composition of claim 1, comprising from 0.02% to 0.20%, by weight of the fabric cleaning composition of an aryliminium organic bleach catalyst selected from the group comprising aryliminium cations, aryliminium zwitterions, and mixtures thereof.

10. The fabric cleaning composition of claim 9, wherein the aryliminium organic bleach catalyst is zwitterionic and selected from the group comprising: 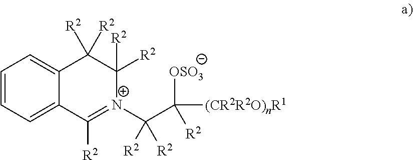
wherein R¹ is selected from the group consisting of: H, a branched alkyl group containing from 3 to 24 carbons, and a linear alkyl group containing from 1 to 24 carbons, and R² is independently selected from the group consisting of: H, a branched alkyl group comprising from 3 to 12 carbons, and a linear alkyl group comprising from 1 to 12 carbons.

11. The fabric cleaning composition of claim 10, wherein the ayliminium organic bleach catalyst is 2-[3-[(2-butyloctyl)oxy]-2-(sulfooxy)propyl]-3,4-dihydroisoquinolinium, inner salt.

12. The fabric cleaning composition of claim 1, wherein the fabric cleaning composition is a bleach additive composition.

13. The fabric cleaning composition of claim 1 wherein the fabric cleaning composition is a granular particulate compositions.

14. A method for removing fabric stains, particularly removing fatty stains, red food stains, or combinations thereof, comprising the steps of:
(a) forming an aqueous bleach-containing wash solution comprising the fabric cleaning composition according to claim 1, a laundry detergent composition, and water;
(b) contacting the fabric with said bleach-containing wash solution; and
(c) subjecting said fabrics contacted with said bleach containing wash solution to a laundry wash cycle.
